(19) United States
(12) Patent Application Publication
(10) Pub. No.: US 2021/0291048 A1
(43) Pub. Date: Sep. 23, 2021

(54) MULTI-PROCESS INTERFACE CONTROLLER

(71) Applicant: WGames Incorporated, Toronto (CA)

(72) Inventors: Daniel KAJOUIE, Toronto (CA); Timur ADIGAMOV, Toronto (CA)

(21) Appl. No.: 17/266,237

(22) PCT Filed: Aug. 9, 2019
(86) PCT No.: PCT/CA2019/000116

§ 371 Date: Feb. 5, 2021

Related U.S. Application Data
(60) Provisional application No. 62/716,455, filed on Aug. 9, 2018.
(60) Provisional application No. 62/729,485, filed on Sep. 11, 2018.

(51) Int. Cl. A63F 13/35; A63F 13/73; A63F 13/79; A63F 13/92

(52) U.S. Cl. CPC A63F 13/35; A63F 13/92; A63F 13/79; A63F 13/73

(57) ABSTRACT

Improved systems (1000), devices (10, 100, 200, 300,400 500, 600), methods (1300) (and 1400), and computer programming products for synchronized processes such as large-scale gaming tournaments (2000). In various aspects the invention provides improved process controllers (10), synchronizing engines (200, 300, 400), and sequestered random number generators (500), and new and improved combinations and arrangements thereof, all configured for cooperation in such ways as to minimize processing latencies without sacrificing security or integrity of the controlled processes.

### CROSS-REFERENCE TO RELATED APPLICATION

This application claims all benefit, including priority, of U.S. Provisional Patent Application Ser. No. 62/716455, filed 8 Aug. 2018 and entitled Synchronized Processing of Parallel Gaming Processes such as Slot Tournaments; and U.S. Provisional Patent Application Ser. No. 62/729485, filed 11 Sep. 2018 and entitled Synchronized Processing of Parallel Gaming Processes such as Slot Tournaments; the entire contents of each of which are incorporated herein by this reference.

### FIELD OF THE INVENTION

The present invention relates to improved systems, devices, and techniques for synchronized processing of multi-user parallel processes, such as networked tournament games.

### BACKGROUND OF THE INVENTION

Systems, devices, and techniques for synchronized processing of multi-user parallel processes, such as networked tournament games, are known. However, such systems, devices, and techniques frequently require database calls and other functions that are either peripheral to or cause unnecessary delays in primary tournament processing, and are therefore slower than they need to be.

### SUMMARY OF THE INVENTION

In various aspects the invention provides systems, devices, and methods, and related stored, machine-readable instruction sets, for improvements in the processing of multi-user parallel processes, such as networked tournament games.

For example, in one aspect the invention provides network communication devices configured to operate gaming applications, for participation by garners in tournament game processes. Such a device can, for example, comprise one or more data processors; one or more each of input, output, and/or input-output devices; machine-readable memory(ies) accessible by the data processor(s); and one or more wireless or other network communication systems. The memory(ies) can comprise data representing stored, machine-interpretable instructions configured to cause the data processor(s) to access, in response to suitably-configured command signals generated by the one or more input device(s), data stored in the memory(ies) and representing one or more tournament gaming applications, and to initiate the application(s). Using the at least one network communication system, the device can route signals representing a join tournament request data set to a gaming server and receive from the same or another gaming server signals representing a tournament authorization token data set, the tournament authorization data set comprising data representing a secure authorization token for participation by a gamer in a tournament game process. Thereafter, in accordance with signals received from the same or another input device, the device can generate a first game action command data set, comprising at least data representing the same or another tournament authorization token and data indicating a game action to be performed by the same or another gaming server on behalf of the gamer, and route the first game action data set to the same or another gaming server for execution. While waiting for results of the gaming action from the gaming server, the device can display on the at least one output device at least one placeholder image. Conditioned upon receipt by the at least one processor of a first game action result data set, which data set comprises at least the same or another tournament authorization token data set and data representing a first game action result, prior to receipt by the at least one processor, from the same or another input device, of signals representing at least one subsequent game action command data set, each subsequent game action command data set comprising at least data representing the same or another tournament authorization token and data indicating a subsequent game action to be performed by the same or another gaming server on behalf of the gamer; the device can display on the at least one output device a user interface communicating a current game status associated with first game action result.

In further aspects, the invention provides tournament gaming servers. Such a server can, for example, include one or more data processors; machine-readable memory(ies) accessible by the at least one data processor; and one or more wireless or other network communication systems. The memory(ies) can store data representing machine-interpretable instructions configured to cause the data processor(s) to receive, from a plurality of gamer communication devices, via the network communication system(s), signals representing a plurality of join tournament request data sets, each such data set comprising at least data associated with an identity of a gamer associated with a gaming account administered by the server and a request to join a tournament game; and, with respect to each received join tournament data set, access in the at least one machine-readable memory data associated with at least one gaming authorization account associated with a corresponding gamer and determine whether the corresponding gamer is authorized to join a tournament associated with the corresponding request. Further actions by the processor can be subject to a number of conditions.

For example, conditioned upon determination that the corresponding gamer is authorized to join the tournament, the processor can generate, in response to each received join tournament request data set, a corresponding tournament authorization token data set, each tournament authorization data set comprising data representing at least a secure tournament participation token and at least one tournament game the corresponding gamer is authorized to access; route each generated tournament authorization token data set to a corresponding gamer communication device; and thereafter receive, from a plurality of gamer communication devices, signals representing a plurality of game action command data sets, each game action command data set comprising at least data representing a secure tournament authorization token associated with an authorized gamer authorized and data indicating a game action to be performed by the gaming server on behalf of the authorized gamer.

Further conditioned upon receipt of a secure authorization token and without further reference to a gamer account associated with a corresponding gamer, the server can execute the indicated game action and update a tournament status data set, generate a game action result data set comprising at least the same or another tournament authorization token data set and data representing a game action result associated with the executed game action; and route generated the game action result data set to the corresponding gamer communication device.

In some embodiments, the invention provides in servers accordance with such aspects of the invention, wherein executing a game action associated with a game action command data set comprises use of an unpredictable number generated by an sequestered unpredictable number generation server in advance of receipt by the gaming server of the game action command data set.

In a further aspect the invention provides sequestered unpredictable number generators, such a generator comprising one or more data processors, secure machine-readable memory(ies) accessible only under the control of the one or more data processors; and one or more wireless or other network communication systems. The secure memory(ies) comprise comprising data representing stored, machine-interpretable instructions configured to cause the data processor(s) to generate one or more pluralities of unpredictable numbers; store the generated unpredictable numbers in the one or more secure memory(ies); receive from one or more independently-controlled one gaming servers, via the network communication system(s), unpredictable number request data sets; responsive to receipt of the unpredictable number request data sets; retrieve from the at least one secure memory one or more unpredictable numbers corresponding to the requests; and route the one or more retrieved unpredictable numbers to the at least one gaming server. In some embodiments, such sequestered unpredictable number generators are configured to generate and store unpredictable numbers generated in accordance with a plurality of generation factors; and to provide unpredictable numbers generated in accordance with selections of the generation factors in response to corresponding requests.

In further aspects and embodiments, the invention provides persistent machine-interpretable media comprising data representing instructions for configuring devices, systems, and servers in accordance with such aspects, and corresponding methods of processing tournament gaming data.

Thus in various aspects and embodiments the invention provides improved systems, devices, methods, and computer programming products for synchronized processes such as large-scale gaming tournaments. In various aspects the invention provides improved process controllers, synchronizing engines, and sequestered random number generators, and new and improved combinations and arrangements thereof, all configured for cooperation in such ways as to minimize processing latencies without sacrificing security or integrity of the controlled processes.

### BRIEF DESCRIPTION OF THE DRAWINGS

Various aspects and embodiments of the invention are illustrated in the accompanying drawings, which are meant to be exemplary and not limiting, and in which like references are intended to refer to like or corresponding parts.

FIGS. 1A, 1B, and 2 are schematic diagrams showing various aspects and embodiments systems, devices, and processes for processing multi-user parallel processes in accordance with the invention.

FIG. 3A-3C are schematic diagrams showing example processing flows and techniques in accordance with various aspects of the invention.

FIGS. 4A-4C are schematic diagrams of network communication devices, and user interfaces, in accordance with various aspects and embodiments of the invention.

### DESCRIPTION OF EMBODIMENTS

In various aspects the invention provides systems, devices, methods, and corresponding stored, machine-readable instruction sets, for improvements in the speed and efficiency of processing of multi-user parallel processes, such as tournament games processed over distributed communication networks. The invention also provides related processes and programming products.

The invention enables improvements in the speed of and synchronization between multi-user parallel processes such as gaming tournaments:

by bifurcating process streams, so that operations pertaining primarily to individual users are processed separately from operations involving multiple users;
through the further bifurcation of processes pertaining to individual users, so that sub-processes pertaining to outcome determinations are separated from sub-processes pertaining to non-critical operations such as generation of informational or entertaining visual displays;
in some embodiments, by generating unpredictable (i.e., random and/or pseudo-random) results of requests for gaming action in advance, and queuing them for release on demand;
optionally, through the further partitioning and synchronization of geographic or other pools or subsets of users (e.g., through the use of processing shards pertaining to regional stages of tournaments, etc.); and
through the use of secure, encrypted tokens to ensure that processes involving individuals users can be properly tracked and memorialized, without need for reference to administrative or accounting databases during rapid gaming sequences.

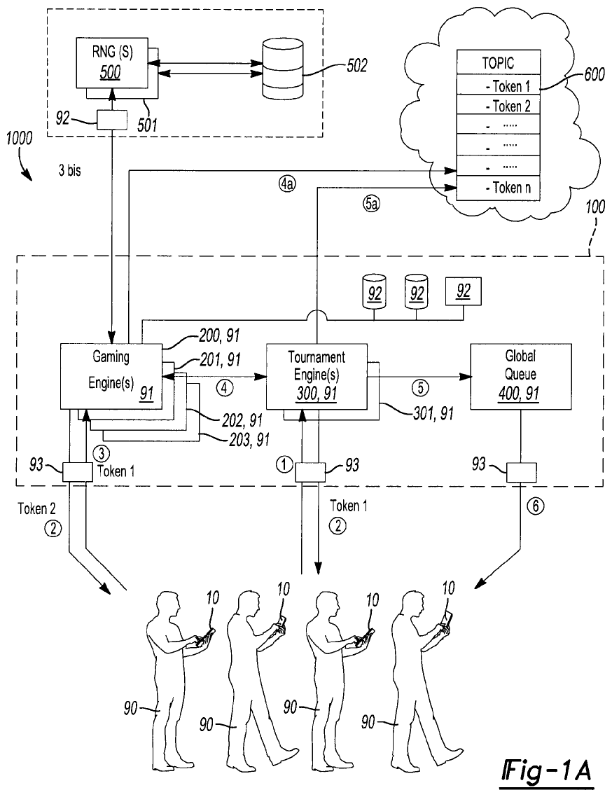

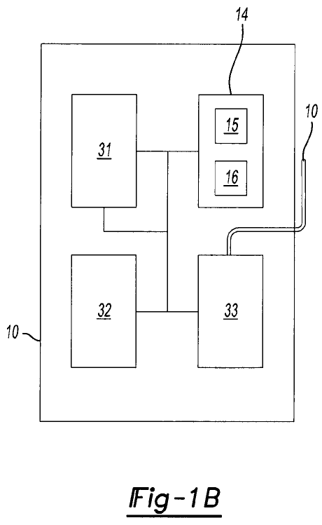

An embodiment of a system 1000 for improved processing of synchronized parallel networked processes, such as tournament games played via a network, in accordance with various aspects of the invention is shown in FIG. 1. In the embodiment shown, a system 1000 comprises a plurality of network or “gamer” communication devices 10, one or more tournament and/or other gaming server(s) 100, sequestered unpredictable number generator(s) 500, and ledger(s) 600.

Systems 1000 can include any desired number(s) of gamer communication devices 10, which can comprise any suitable number of processor(s) 31, memory(ies) 32, input device(s) 15, output device(s) 16 (and/or input/output device(s) 14, such as touchscreen displays), and wireless or other network communication system(s) 33, as shown schematically in FIG. 1 B, as well as any other suitable or desired components or systems; and can be communicatively linked to server 100 by wireless, wired, or any other suitable network communications systems and devices. As described below, devices 10 can operate gaming applications for participation and control of tournament and other synchronized, parallel processes described herein. In doing so, device(s) 10 can access suitably-configured gaming applications, which can either be hosted as machine-readable instruction set(s) stored in memory(ies) 32 on the device(s) 10; or on server(s) 100, and accessed via network browsers or other means; or both, through the use of distributed processing techniques. Gamer communication devices can be implemented in any form(s) suitable for accomplishing the purposes disclosed herein, including for example mobile (smart) phones, desktop and/or laptop computers, tablet devices and/or other personal data assistants, and/or server- or enterprise-class systems.

Tournament or other gaming server(s) 100 can comprise any suitable number of processor(s) 91, memory(ies) 92, and wireless or other network communication system(s) 93, as shown schematically in FIG. 1A, and can be configured to control and/or to otherwise administer or facilitate gaming tournaments conducted between users 90 of pluralities of gamer communication devices 10, as described herein; and can be implemented in any form(s) suitable for accomplishing the purposes disclosed herein, including for example mobile (smart) phones, desktop and/or laptop computers, tablet devices and/or other personal data assistants, and/or server- or enterprise-class systems.

In the embodiment shown in FIG. 1, for example, a gaming server 100 is implemented in the form of an enterprise- or server-class system, with a plurality of processors (“gaming engines”) 91, 200, 201, 202, etc., dedicated to parallel processing of lower-level tournament processes, such as individual games or rounds of a tournament; and one or more processors (“tournament engines”) dedicated to administration or control of higher-level processes, such as intermediate- or top-level tournaments. As will be understood by those skilled in the relevant arts, when they have been made familiar with this disclosure, the dedication of one or more independent processors to each of multiple tournament or skill-level games is scalable to any desired number of lower, intermediate, upper, and supreme levels, so that arbitrary numbers of tournaments of arbitrary numbers of levels, with arbitrary numbers of participating gamer communication device(s) 10, can be accommodated.

In other embodiments, the functions described herein for engine(s) 200, 300 can be implemented through the use of a single-processor machine, using any suitable form of processor sharing and/or prioritizing mechanisms or methods.

Sequestered and/or other forms of random, pseudo-random, and/or otherwise “unpredictable” number generators (“RNGs”) 500, 501 can be provided in any desired numbers, and through the use of any desired types, forms, or configurations of processors, including for example server- and/or enterprise-class systems, desktops, laptops, etc. In some embodiments, RNG(s) 500 can be sequestered from gaming server(s) 100 and user devices 10 by the use of suitably-configured data access and control technologies, including the use of cryptography, dedicated access lines, firewalls, etc., so that processes of determining rapid or otherwise unpredictable numbers are not controllable by such servers or devices; except that authorized systems or devices may be enabled to request unpredictable numbers generated according to desired specifications, including for example application of multiple parallel and/or serial randomization processes. Sequestration can, for example, involve any types or extents of measures that securely enable that independence and integrity of generating unpredictable numbers is not compromised. For example, in jurisdictions where virtual slot and other types of games are subject to governmental or administrative control, control of the sequestered server(s) 500 can be retained by a governmental or other administrative body, or by a separate, distinct, and independent contractor, whose relationship to gaming server(s) 100 is strictly controlled.

Among the significant advantages offered by sequestered servers 500 in accordance with such aspects of the invention are increased speed in processing of synchronized processes such as virtual slot and other gaming tournaments. For example, gaming server(s) or administrators 100 can arrange with administrators of such servers 500 in advance for generation of numbers generated through the use of any desired numbers of unpredictable factors, or using any desired types, numbers, and combinations of unpredictable algorithms. Thereafter the server(s) 500 can store corresponding numbers in memory(ies) 502, so that when they are requested by server(s) 100, 200, they can very quickly be retrieved and returned for use by the processor(s) 91, 100, 200, with minimal delay in processing time, particularly when algorithm(s) requiring significant amounts of time for generation are applied.

As shown in FIG. 1, improved processes for synchronizing and expediting parallel networked data processes can be considered to begin when any one or more individual users 90 initiate, at (1), a process of accessing a server, platform, or other signal processor(s) 300 configured to control one or more tournaments or other parallel processes associated with a gaming server or other service provider 100. To join such a multi-user process, such a user 90 can use a dedicated gaming app or general purpose browser of the user's network communication device 10, and, for example, select a tournament initiation command icon provided via a graphical user interface (GUI) provided on a touchscreen or other input/output device 14, 15 of the user 90's gamer communication device 10. Selection of such a GUI command item through a user's gaming app or browser can for example cause a command comprising at least the following data fields to be generated and routed to the server/platform 100, 300 using a network communications system such as a radio or other wireless device, a modem/digital signal processor, etc.:

<user ID/address><tournament ID><participation flag>

where:
<user ID/address>=network address, or other suitable reference, useful for unique and optionally secure signal communications with the originating device 10 and/or user 90
<tournament ID>=identifier associated with a specific tournament, or a type or class of tournament, or a number of types or classes of tournament the user wishes to join.
<participation flag>=flag indicating to the addressee server that the requesting user wishes to join a tournament or other process. In some embodiments, the flag can be implemented implicitly, with the presence of a tournament ID implying that the user 90 desires to join a tournament.

Upon receipt, the server/platform 100, 300 can parse the request and confirm that the requesting user 90 is authorized to access and participate in the tournament, or a tournament of a requested type. For example, the server can use the user's ID to confirm that the user is properly associated with any suitable gamer, credit, debit, or other financial accounts; that any associated financial accounts are in good standing; that the user is attempting to access the tournament from a jurisdiction that does not prohibit or otherwise restrict the user's participation, etc. Such accounts can be stored, maintained, or otherwise accessed or controlled by or under the authority, for example, of the gaming or tournament server 100 to which the request was routed.

The user's ID can comprise any one or more data items or sets suitable for identifying the user 90 as an authorized individual or entity, with any degree of uniqueness adequate for the purpose. For example, the user's personal name, an identification number, password, or code, or any other string(s) of characters or symbols can be used, if it is sufficient to uniquely associate the requesting user 90 with a source of funds or other form of authorization for the purposes of the server or platform 100, 300.

In various embodiments the user's ID can, in addition or in the alternative, consist of, include, or otherwise be associated with any further useful data or information. For example, it has been found advantageous in some embodiments of the invention to include a unique identifier associated with one or more devices 10 authorized for use by the user 90 in accessing the game or other multi-user process. As a specific example, one or more hardware keys associated with a particular device 10 used by or otherwise associated with the requesting user 90 may be used. Such hardware keys can include serial numbers or other numbers associated with the device by the device manufacturer, and/or assigned or otherwise designated by the server 100, 300, etc., and can be used instead of, or in addition to, unique identifiers associated with user(s) 90.

To determine whether a requesting user 90 is authorized to participate in a tournament, game or other process associated with the request routed at (1), the server 100, 300 can compare the hardware key and/or other ID element(s) with stored data controlled by the server 100, 300, representing suitable authorizations, using for example known table look-up or other processes.

Upon confirming that a requesting user is authorized to access a requested tournament, or a tournament of the requested type, the server 300 can add the gamer 90's ID to a list associated with an existing tournament, or can begin building a new tournament, to be initiated when a suitable number of further gamer(s) 90 have been identified. When a tournament has been satisfactorily established through identification and authorization of a sufficient number of participants, at (2) in FIG. 1 the server 100, 300 can return to the user 90 via the user's ID/Address a tournament or game authorization data set enabling the user 90 to access and participate in the tournament. Such a tournament or game authorization data set can, for example, comprise at least data representing the following information:

<user ID><game/tournament ID><authorization flag/secure token>

### Where:

<user ID/address>=network address, or other suitable reference, useful for unique and optionally secure signal communications with the originating device 10 and/or user 90
<game/tournament ID>=identifier associated with tournament or other process in which the user 90 is authorized to participate
<authorization flag/secure token>=flag, identifier, or other data representing a trustable authorization for the corresponding user 90 to participate in the tournament,

Authorization flagging can be accomplished explicitly or implicitly; for example, the provision of a suitably-configured token, accompanied by a game/tournament ID, can be interpreted by server 100 and server components 200, 300, 400 as authority for accessing and participating in the tournament or process.

The secure token provided at (2), and optionally used in subsequent processes, and other tokens in accordance with such aspects of the invention, can be or comprise any suitably unique and/or secure data or information set(s), and can be encrypted or otherwise provided with secure attributes. For example, in some embodiments of the invention a secure token returned at (2) can consist of or include data representing an account balance, or other current status, associated with a user. For example, such a token can represent, in whole or part, of any or all of the identity of a user, or an account or identify associated with a user; a balance in an account or associated with the user 90 at the start or initiation of a tournament or process, or at the end of any game, round, or other intermediate result; a hardware key associated with the user; a balance associated with a source of payment or other financial resources and associated with the user; a current status of a user with respect to a game or other process, such as an accumulated score, or number of points; or any type of end, current, or interim game state or experience, such as ‘alive’, ‘dead,’ ‘(n)th place’, ‘(x) points,’ etc.

Another important feature of secure token(s) in accordance with such aspects of the invention, which can for example be particularly useful in preventing or reducing fraud or other forms of abuse in tournaments or other multi-participant data processes, is inclusion of data representing one or more sequential operation identifiers (SeqOpID(s)). Such identifiers can for example represent a count of discrete operations initiated by a gamer 90 of a device 10 participating in a multi-participant process. For example, each time such a user 90 initiates a new spin, new roll of virtual dice, indicates any preference, quits, starts, or takes other action in a tournament, game, or other process, the user's SeqOpID can be incremented and the incremented value can be stored as all or part of the user's secure token for use in routing the token as part of a corresponding execution request or command. At the end, or any other suitable points in the tournament or other process, the server or platform 300 can check all or any portion of the actions initiated by the user 90 to ensure that all sequential operations have been uniquely reported (so that no fraudulent double uses of a SeqOpID can made), with no operations skipped, and optionally that they make logical sense in the order executed.

Thus in various embodiments secure tokens in accordance with the invention can comprise data representing some or all of the following information:

<UserID/address><hardware key><balance><game/tournament ID>

<user status><SeqOpID>

### Where:

<UserlD/address>=any network address, name, number, code or other suitable reference, useful for uniquely and optionally securely identifying the user or gamer 90 authorized to participate in the tournament or other process
<hardware key>=unique identifier associated with a device 10 associated with the user or gamer 90 authorized to participate in the tournament or other process
<balance>=a balance associated with a funding source such as a currency or points-based financial or value account associated with the user, or a flag indicating that the user has sufficient funds for participation, or other authorization flag
<game/tournament ID>=identifier associated with tournament or other process in which the user 90 is authorized to participate
<user status>=any additional personal or gaming information associated with the user 90 associated to participate in the tournament or other process
<SeqOpID>=count of discrete operations initiated by a gamer 90 of a device 10 participating in one or more multi-participant and/or other processes

In any case, the secure token provided at (2) can be used, and optionally updated, by any of system(s) or device(s) 90, 200, 300 at any desired or otherwise appropriate steps, or at all steps, in subsequent processing, as a means of confirming for other servers or devices both authority of the user 90 to participate in the tournament and the state of the user's gaming account, or other status associated with the user and the tournament.

For example, at (3) in FIG. 1, under further instructions provided by the user 90, the user's device 10 and/or gaming app can generate one or more game execution or game action command data sets and route them to a gaming engine 200 configured for execution of the requested game in accordance with preset rules. Such game execution or game action command data sets can, for example, include at least some or all of:

<user ID/address><game and/or tournament ID><command flag>

<secure token><(optional) date/time stamp>

### Where:

<UserID/address>=any network address, name, number, code or other suitable reference, useful for uniquely and optionally securely identifying the user or gamer 90 authorized to participate in the tournament or other process
<game/tournament ID>=identifier associated with tournament or other process in which the user 90 is authorized to participate
<command flag>=code or other identifier indicating the gaming action the user desires to take (e.g., spin, shoot, move, etc.)
<secure token>=any secure authorization identifier as described above, can for example include either or both of SeqOpID and user account or value balance)
<(optional) date/time stamp>=date/time at which the command data set was generated, routed, received, or processed by the receiving server

On receipt of a game action command data set, the gaming engine 200 can apply its own date/time stamp, if a suitable stamp is not provided with the execution command data set, or if separate time stamping is otherwise desired. The gaming engine can then parse the incoming data set and execute any instructions associated with the command flag.

If execution of the game action command received at (3) is associated, by rule or otherwise, with any actions potentially affecting any account(s) or balance(s) associated with the secure token, then a gaming engine 200, whether it is a separate physical or logical device, or simply a discrete logical operation of a larger gaming program structure, can update the secure token if/as required following execution of each command, such as a new spin of a virtual slot machine, or generate a new token, and as shown at (3a) can thereafter return the new or updated token either to the requesting user's device 10 or retain it, for a definite or indefinite period of time; or route it to a tournament engine 300 responsible for synchronizing processes associated with multiple users 90 participating in the tournament.

For example, in an embodiment relating to a virtual slot tournament, if a user 90's account is charged, or debited or credited in connection with each virtual spin action initiated, then a gaming engine can update the user's token data set, and route an updated token to the user's device 10 for use in a next gaming application. Many variations are possible. For example, in an embodiment in which a user 90's account is debited at the end of a round, or accumulated points or rewards are to be delivered to a user, or at the beginning or end of a tournament, the token can be updated at the beginning or end of the round or tournament, as appropriate, with any desired number of individual actions, such as spins, having no effect during execution of a round. In such cases, the same token data set can be passed back and forth between the user 90's device 10 and the gaming server 100 throughout the round or tournament play.

In the same and other embodiments of the invention, the user's token is always updated, or re-generated, with updated account/balance information and an updated SeqOpID, if appropriate, and the old token is routed to server/platform 300 and/or other server or processor for anti-fraud processes via checking of SeqOpIDs and other account or other updates and confirmations.

In further embodiments, an account-related portion or aspect of the token remains unchanged during lower-level rounds or games, until the end of upper level rounds or tournaments, while the SeqOpID, if used, is updated upon execution of each individual action, such as each pull or spin of a virtual slot machine; or upon execution of a set of defined actions, such as in connection with each shot fired in a combat simulation tournament or virtual skeet shooting application.

In further embodiments, both an account-related portion and a SeqOpID are updated only at interim points, such as the end of a round, game, or tournament, while either or both portions remain unaffected by individual gaming actions, such as spins.

For example, if the tournament involves a social game with a real or virtual cost associated with execution of various commands, then such real or virtual cost can be deducted from a value stored within or otherwise represented by the token. If the tournament involves a game of chance, such as virtual slot tournament, in which rewards are sometimes made to users upon occurrence of various results (e.g., if the user wins a virtual slot event), then a points value associated with the user's token can be updated for further processing.

In any case, when a token is returned to the user 90, whether updated or not, either on the same or another device 10, the user 90 can repeat either the process (1) of starting a new tournament process at the server/platform(s) 200 or the process (3) of executing one or more actions at the gaming engine(s) 200 until the user's participant in the multi-player process, or any stage thereof, is complete.

It will be noted that, among other effects, the use of gaming engine(s) 200 and secure tokens in such manner can eliminate the need for continual routing, reading, parsing, and processing of data between user devices 10 and engines 200, 300 etc. In such cases processing speeds for both individual and parallel processes can be increased significantly.

Similarly, use of secure token data sets for processing of tournaments and other processes where rapid or otherwise repeated execution of game action commands are desired can eliminate or reduce the need for a tournament or gaming engine 200, 300 to refer to an internal or external database to check account information and the like; this too can significantly increase processing speeds. For example, in an embodiment in which a user 90's account is verified and adequate funds or value are secured at the beginning of a tournament, the need to check the user's account at multiple interim steps, such as in connection with individual virtual slot pulls, can be eliminated, so that delays associated with account-checking calls and data returns do not slow the execution of multiple slot pulls or other action commands until the tournament (or interim points such as round completion) is completed.

Thus it may be seen that use of secure token data sets in accordance with the disclosure enables, among other advantages, manifold expansion or scale up of the number of users 90 that can be allowed to participate in virtual tournaments, and the number of virtual tournaments that can be administered by server(s) 100 and/or engine(s) 200, 300.

When a user 90 has completed a suitably-discrete interim or final step in the process of the tournament he/she is participating in, at (4) in FIG. 1 the gaming engine 200 can forward to a responsible higher-level (e.g., tournament) engine/platform 300 data representing the user's interim or final performance. For example, in a virtual slot tournament, when a user 90 has reached an established timing point, or has executed a specified number of slot ‘pull’ commands, then the state of the user's winnings (or losses) can be computed and a suitably-configured user game status data set can be generated by the gaming engine 200 and routed to the tournament engine 300. Such a data set can be as simple as:

<user ID/address><game and/or tournament ID><result>

### Where:

<UserlD/address>=any network address, name, number, code or other suitable reference, useful for uniquely and optionally securely identifying the user or gamer 90 authorized to participate in the tournament or other process
<game/tournament ID>=identifier associated with tournament or other process in which the user 90 is authorized to participate
<result>=the interim or final score, winnings, losses, or other result of the user's participation in the tournament or process

Alternatively, all operations, e.g., the result of each individual slot pull or other gaming action, affecting a user's status or performance with respect to the tournament or other process, or any account(s) or balance(s) associated with a user 90, can be reported to the server/platform 300 through the use of such user performance data sets. Embodiments of this type can be particularly useful where, for example, a gaming engine 200 is designed for very low latency, in order to improve the speed and coordination of multi-user process(es). Latency can be decreased by, for example, eliminating any requirement for the gaming engine 200 to track users' status, or do anything other than generate gaming results.

In any or all such cases, such user performance data sets can, for example, comprise:

<game/tournament ID><user ID><gaming engine ID>

<date/time stamp><user game or operation result/account status>

where for example data representing the “user game or operation result/account status” can comprise any data or other identifiers useable by the server/platform 300 for updating desired aspect(s) of the user's status or performance. For example, a user's current or stage standings in a tournament, points balance or score, etc., can be represented.

At or about the same time, at (2) again the user's secure token data set can be returned to the user, or forwarded to any desired component of the gaming server 100. Alternatively, or in addition, the secure token can be routed to a sequestered data repository or archive 600, such as a third-party secure memory or a suitably-secure block chain data set.

As shown at (4a) and (5a), each time any of device(s) 200, 300, 10, etc., updates a token, a user performance data set, and/or any other data associated with a user 90, a record reflecting the update can be set aside in a secure archive. Such archive(s) 600 can be operated, maintained, or otherwise administered by an entity which also controls system 100, or any one or more components thereof, or by any desired third party(s), and can be implemented using, for example, block-chain or other secure technologies.

When processing by the tournament engine 300 has reached a suitable point, e.g. when the tournament is complete or when a local or regional round has been completed, at (5) the tournament engine 300 can forward an updated tournament status data set, and/or any general and/or individual reports, to a global queue 400, for routing at (6) to individual users or groups of users. In some embodiments, including for example those involving virtual slot tournaments or other multi-tiered, multi-player games, interim results can be shared with all users at desired levels. For example, a server/platform 300 and/or a global queue server 400 can update all users on interim slot results in real time, using all data received or generated by the server/platform 300 from gaming engine(s) 200, so that at each stage each user 90 can be informed of the performance of team-mates, opposing team members, opposing teams, and results of other tournament tiers or groupings, as desired.

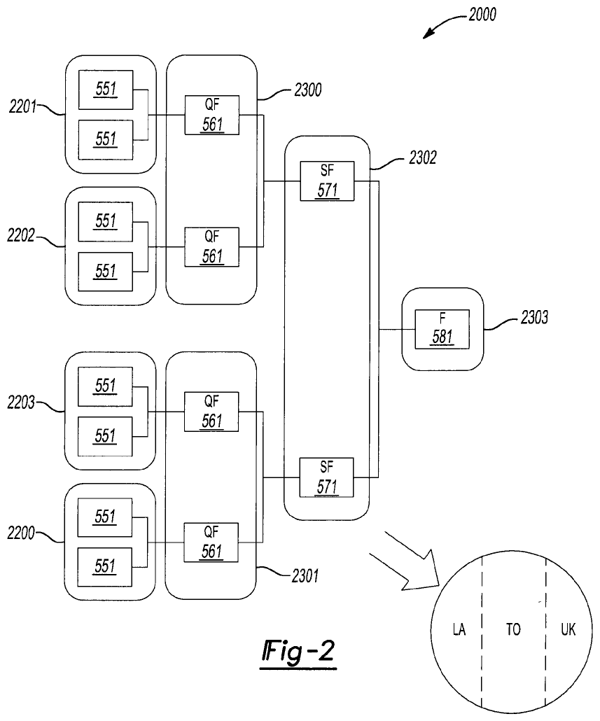

Among the advantages offered by the invention to enable configuration of servers/platforms 300 to implement multi-player games in tiers, or levels, is the use of various servers or processing engines to handle regionally-defined or other types of processing “shards”, or logical sub-groupings. For example, local or regional tournaments “LA,” “TO,” and “UK” can be run in parallel, using multiple servers, or multiple instances of server-implemented processing services, 301, 302, etc., as shown in FIG. 2. For example, as shown in FIG. 2 one pattern of logical grouping can be based on general geography, with a separate grouping 2000 being assigned to each of three distinct regions LA, grouped in association with Los Angeles; TO, grouped in association with Toronto, and UK, grouped in association with the United Kingdom. Within each grouping 2000, for example groupings 2200, 2201, 2202, 2203 of initial rounds 551 can processed by each of a plurality of servers or engines 200, 201, 202, 203; groupings 2300, 2301 of quarter final rounds 561 by tournament engines 300, 301; and grouping 2302 of semi-finals 571 by a further tournament engine 300. A grouping 2303 for final round 581 involving regional winners of the LA, TO, and UK rounds can be processed by a further tournament engine 300.

As will be appreciated by those skilled in the relevant arts, the novel architectures and processing techniques disclosed herein open a very wide variety of logical groupings for increased processing efficiency.

Alternatively, or in addition, processing of multi-user processes by gaming engine(s) 200 as described above can be improved through the bifurcation of processes pertaining to individual users, so that sub-processes pertaining to higher-priority determinations such as spin, game, round, or tournament outcomes are segregated from sub-processes pertaining to non-critical operations such as generation of informational or entertaining “placeholder” visual displays.

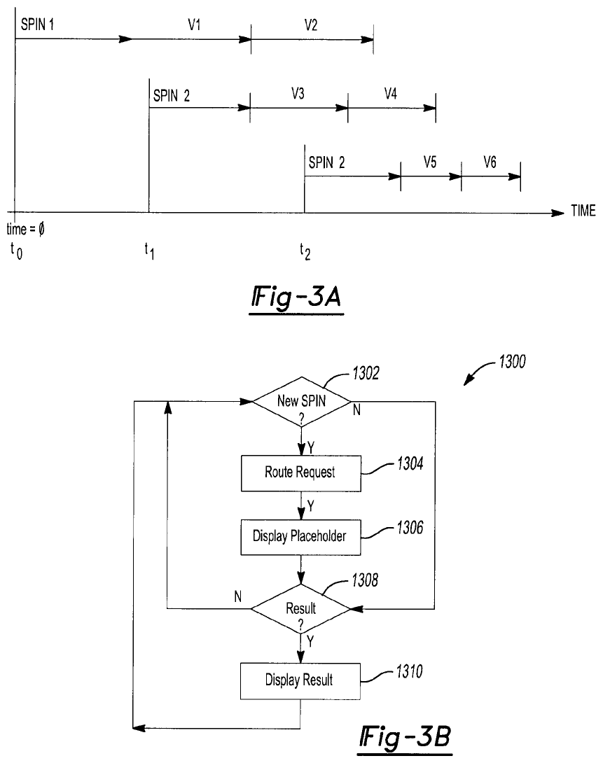

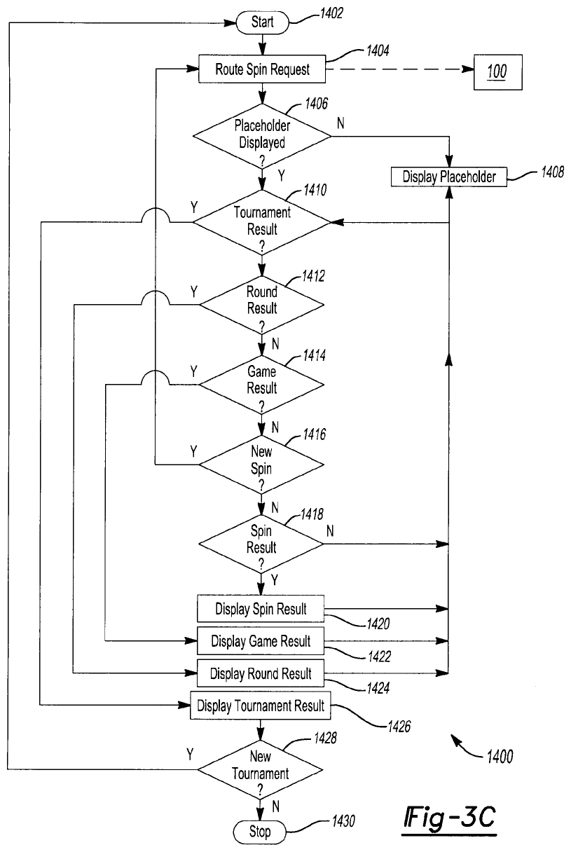

For example, as shown in FIG. 3A, a user 90 has entered, in rapid succession, a plurality of ‘spin’ or other ‘play’ or action commands SPIN 1, SPIN 2, SPIN 3, at times t₀, t₁, t₂ respectively. If, as shown in FIG. 3A, a ‘spin’ command is configured to result in (i) execution of an intermediate or final outcome-determining ‘spin’ process, such as might for example be accomplished through the use of a random-number generator 500, and (ii) a non-outcome determinative process such as generation of an animated display representing the spinning of one or more slot reels or roulette wheels, then as shown processing of non-determinative processes can be postponed, side-lined, or otherwise subordinated in priority, or terminated, in favor of outcome-determinative processes, as shown.

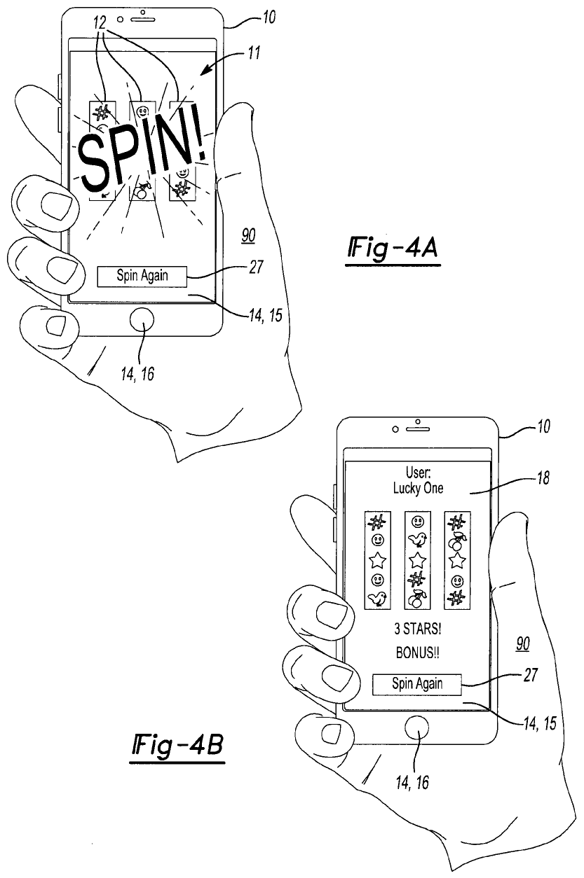

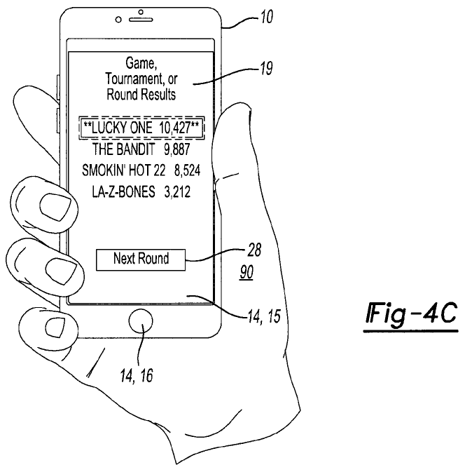

For example, as shown in FIGS. 3A, 4A and in the case of a virtual slot application, once a user has generated a first ‘spin’ command ‘SPIN 1,’ a GUI placeholder animation V1, 11 representing one or more spinning wheels 12 of a slot machine can be generated by either or both of the gaming engine(s) 200 and the user's device 10, and displayed on an output screen 14, 15 of the user's device 10 until a suitable random result has been generated, at which point the result V2, 18 can be displayed, as shown in FIG. 4B. If the user routes a succession of such action commands SPIN2, SPIN3, etc., through selection of a “SPIN” command or action input device or icon 27, 14, 16 faster than corresponding outcomes V2, V4, V6 can be generated, then display of the animation or other placeholder GUI V1 can be continued until any one or more interim or final results V2, V4, etc., have been generated. For example, spinning wheel images 11, V1, V3, V5, etc., can be interspersed with rapid displays of interim results 18, or spinning may continue uninterrupted, without intermediate display of 11, V3, V5, etc., until a final result 19, V6 is determined (FIG. 4C). In any case, bifurcation of action processes from non-critical display processes can enable gaming engine(s) 200, 500 to advance the tournament or other multi-user process without slowing the process down in order to display non-critical animations or graphics for individual users.

Embodiments of process flows 1300, 1400 illustrating advantages and implementation of such bifurcation aspects of the invention on a device 10 used by a gamer 90 are shown in FIGS. 3B and 3C. In the embodiment shown in FIG. 3B, a process 1300 can be considered to begin at 1302 with receipt from the user of a command input indicating that the user wishes to initiate a virtual slot machine ‘pull’ or other action as part of the user's participation in a multi-user process. When such an action command is received, at 1304 the user's device 10/process app can forward to a gaming engine or other processor 200 a request for execution of the command and in return can receive a result of the action, which may for example be determined in whole or in part by a RNG 500 as described below. At 1306, the device 10/app can cause a GUI representing a visual placeholder 11 such as an animation depicting spinning of one or more virtual slot machine reels 12 can be displayed, for example as confirmation to the user 90 that the requested command is being executed.

Among a variety of advantages offered by such processes is that once a game action data set has been routed, the receiving gaming server 100, 200 has passed along all information required to process the requested action; the requesting device 10 can turn its attention to other processes, including for example the immediate generation of further action requests, such as virtual slot spins. In order to confirm for a requesting gamer 90 that a requested action, or type of action (such as one or more spins) has been routed and is being processed, various forms of placeholders can be displayed on the user's device, reflecting for example the nature of the action requested, such as a virtual slot spin (see FIG. 4A), an arrow or other missile in flight, a racing car, etc. In order to save time and processing effort, suitable placeholder images, and templates for results displays (discussed below) can be cached or otherwise stored in memory(ies) 32 on the user 90's device 10, and optionally updated from time to time by server(s) 100 as part of initiation or other background processes. Among other advantages, this enables a gamer 90 to enter as many game action commands (e.g., spins) as they like, rapidly, without having to wait for return of results from a gaming server 100.

For example, at 1308 the device 10 can confirm whether a result of the new spin detected at 1302 has been received. If not, the placeholder GUI 11 generated at 1306 can be maintained, and control can return to 1302 to determine whether a new spin or action command has been received.

The process 1302-1308 can continue until at 1310 one or more result data sets are received from the gaming engine(s) or other processor(s) 200, at which point the result can be displayed or otherwise processed. See, for example, FIGS. 4B and 4C. As noted above, suitable images, or image templates, may be cached or otherwise stored in memory(ies) 32 of the user's device 10, in order to minimize network communications and associated process latencies. For example, user name(s) and points results, etc., can be routed along with such results data sets, and used to complete display data sets that already include video, audio, and other data.

Thus in various aspects and embodiments the invention may be seen to provide network or gamer communication devices 10 configured to operate gaming applications for participation by garners 90 in tournament game processes 2000. Such devices 10 can comprise one or more data processors 31; any desired types and/or number of input device(s) 14, 15, output device(s) 14, 16, and machine-readable memory(ies) 32 accessible by the data processor(s) 31; and any desired numbers and/or types of wireless or wireline network communication systems 33. Such memory(ies) 32 can comprise data representing stored, machine-interpretable instructions configured to cause the one or more data processors 31 to, in accordance with signals received from at least one of the input device(s) 14, 15, access data in the at least one memory 32 representing a tournament gaming application, initiate the application, and, optionally conditioned upon receipt of further command signals from input device(s) 14, 15, use the at least one network communication system 33 to route signals representing a join tournament request data set to a gaming server/engine 100, 200, 300.

Subject to suitable processing by the gaming server/engine 100, 200, 300 as described herein, the device 10 can use the same or another network communication system 33 to receive from the same or another gaming server/engine 100, 200, 300 signals representing a tournament authorization token data set, the tournament authorization data set comprising data representing a secure authorization token for participation by a gamer 90 in a tournament game process 2000. The secure authorization token can comprise data representing various types of information, as described above.

At 1302, in accordance with signals received from the same or another input device 14, 15, processor(s) 31 can generate a first game action command data set, the first game action command data set comprising at least data representing the same or another tournament authorization token and data indicating a game action to be performed by the same or another gaming server on behalf of the gamer, as described above; and at 1304 can route the first game action data set to the same or another gaming server or engine 100, 200, 300.

With the game action command data set routed at 1304, at 1306 processor(s) 31 can cause the device 10 to display on at least one output device 14, 16, at least one placeholder image 11, as shown in FIG. 4A. Conditioned upon receipt at 1308 by the at least one processor 31, from the same or another gaming server/engine 100, 200, 300, of a first game action result data set, comprising at least the same or another tournament authorization token data set and data representing a first game action result, prior to receipt by the processor of signals generated by the device 10 and representing at least one subsequent game action command data set, the processor(s) 31 can cause the device 10 to display on the at least one output device 14, 15 a user interface 18, 19 communicating a current game status associated with first game action result.

A second embodiment 1400 of a process flow implementing such process bifurcation aspects of the invention is shown in FIG. 3C. In the embodiment shown in FIG. 3C, process 1400 is adapted for implementation in respect of a multi-level tournament process such as tournament 2000 shown in FIG. 2, directed to a multi-gamer virtual slot tournament comprising a ‘spin’ level 2200-2203; ‘game’ level 2300, 2301; ‘round’ level 2302; and ‘tournament’ level 2303.

Process 1400 of FIG. 3C can be considered to begin at 1402 when a gamer 90 using a network or gamer communication device 10 uses one or more input devices 14, 15 to cause one or more processor(s) 31 to access memory(ies) 32 and initiate a virtual slot or other multi-level tournament gaming application residing on either or both of the user 90's device 10 and a gaming server 100, and to route signals representing a join tournament request data set to a gaming server 100, via network communication device(s) 33.

Upon receipt, via network communication system(s) 33, of a tournament authorization token data set generated by the responsible gaming server/engine 100, 200, 300, and comprising, for example, data representing a secure authorization token for participation by a gamer in a tournament game process as described herein, nested logical loops 1404-1426 can be initiated, with processing continuing until the requested tournament is complete.

For example, the gamer 90 can use input device(s) 14, 15 to generate a first game action command data set, such as a ‘spin request’ adapted to cause activation of a virtual slot ‘pull,’ and at 1404 the device 10 can route the game action command data set to the corresponding gaming server/engine 100, 200, 300. In such a case the first game action command data set can comprise, for example, an identifier “user ID/address” associated with the requesting gamer 90, an identifier associated with the game/tournament the gamer 90 has joined, a flag or other indicator indicating that a ‘spin’ action has been requested, a secure token, and optionally either or both of a date/time stamp and a sequential operation identifier “SeqOpID”.

At 1406 the processor(s) 31 can determine whether a placeholder display 11 has been generated and presented on an output device 14, 16 of the device, as shown for example in FIG. 4A. If no placeholder has been displayed, then at 1408 the processor(s) 31 can cause one to be displayed, by for example accessing suitable image and/or video data in memory(ies) 33 and, in accordance with logic of the tournament gaming application initiated at 1402, writing suitable image/video data and command signals to one or more buffers of the display 14, 16.

Once a placeholder display has been presented, loop 1404-1428 can continue with a determination at 1410 whether any tournament results data sets have been received from server(s)/engines 100, 200, 300. If so, at 1426 a suitable results screen 19 can be generated and displayed on output device(s) 14, 16, as shown in FIG. 4C; and control can be returned to the tournament execution loop at 1410 through generation and routing, at 1428, of a suitably-configured ‘next tournament’ or ‘next round’ request data set by, for example, selection of a “new tournament” or “next round” command icon 28 as shown in FIG. 4C. If no tournament results data has been received, i.e., if the tournament 2000 continues; at 1412, for example, a determination can be made whether any data sets representing results of a “round” 2302, or other intermediate-level results, have been received from server(s)/engines 100, 200, 300; if so, at 1424 a suitable results screen 19 can be generated and displayed on output device(s) 14, 16, as shown in FIG. 4C; and control can be returned to the tournament execution loop at 1410 by through generation and routing, at 1424, of a suitably-configured ‘next round’ request data set by, for example, selection of a “next round” command icon 28 as shown in FIG. 4C.

If no round or other intermediate results data has been received from a responsible server/engine 100, 200, 300, i.e., if the round or level 2302 continues; at 1414 a determination can be made whether any data sets representing a game 2300, 2301 making up a part of a “round” or other intermediate- or lower tournament level 2302 have been received from server(s)/engines 100, 200, 300; if so, at 1422 a suitable results screen 19 can be generated and displayed on output device(s) 14, 16, as shown in FIG. 4C; and control can be returned to the tournament execution loop at 1410 by generation and routing, at 1422, of a suitably-configured ‘next game’ request data set by, for example, selection of a “next game” command icon 28 as shown in FIG. 4C.

If no game or lower-level results data has been received from a responsible server/engine 100, 200, 300, i.e., if a game 2200-2203 continues; at 1416 a determination can be made whether any data sets representing a new ‘spin’ or other game action command has been generated by input device(s) 14, 15. If so, then at 1404 a corresponding subsequent game action command data set can be routed to the responsible server(s)/engine(s) 100, 200, 300, and process 1406-1416 can be restarted; and control can be returned to the tournament execution loop at 1410.

If no new spin or other game action command has been generated, at 1418 a determination can be made as to whether data representing the results of any previously-requested spins or actions has been received. If so, then at 1420 processor(s) 31 can access suitable image/video data and cause an output device 14, 16 to present a suitably-configured spin or action results display 18, as shown for example in FIG. 4B, and control can be returned to the tournament execution loop at 1410 by generation and routing of a new spin or game action command by, for example, selecting an interactive command icon 27 as shown.

It may be seen that applying logical steps 1404-1428 can result in the execution of a complete process representing tournament 2000 by a gamer 90 using a device 10; of course each participant in the tournament 2000 would experience a similar process. When the tournament 2000 and any related or otherwise-desired processes are complete, at 1428 the user 90 can be offered, by means of suitably-configured tournament request or invitation data sets and displays on input/output devices 14, 15, 16, an opportunity to join a new tournament, or alternatively to take part in another process such as a single-player game, social media, etc. By selecting a command-generation icon 28 (FIG. 4C), or otherwise generating a suitably-configured new tournament request data set, the user 90 can cause processor(s) 31 to restart the nested logical loops 1404-1426 and launch a new tournament.

In further aspects, the invention provides server(s) 100 and/or engine(s) 91, 200, 300, for handling gaming requests generated by gamer communication devices and for administering and otherwise controlling tournament and other gaming processes in accordance with the foregoing. For example, in various aspects and embodiments the invention provides tournament gaming server(s) 100 comprising one or more data processors 200, 201, 202, etc., and/or 300, 301, etc.; machine-readable memory(ies) 92 accessible by the data processor(s) 91, 100, 200, 300, etc.,; and suitably-configured network communication system(s) 93. In such aspects and embodiments memory(ies) 92 can store machine-interpretable instructions, such as programmed gaming application data sets and/or general-purpose network browsers, configured to cause the data processor(s) 91, 100, 200, 300 to implement virtual slot and other tournament gaming process(es) 2000 by receiving, from each of a plurality of gamer communication devices, via the one or more network communication systems, signals representing a plurality of join tournament request data sets, as shown for example at (1) in FIG. 1. Each join such tournament request data set can comprise at least data associated with an identity of a respective gamer 90 associated with a gaming account administered by the gaming server and flag or other data representing a corresponding request to join a tournament game 2000.

Processor(s) 91, 100, 300, can assess received join tournament request data sets by accessing, in the at least one machine-readable memory, data associated with a gaming account associated with each corresponding gamer 90 and determine whether the corresponding gamer has sufficient credit in points or monetary value, or is otherwise authorized to join a tournament 2000 associated with the identifier included in the corresponding request.

At (2) in FIG. 1, on condition that the corresponding gamer 90 has been confirmed to be authorized to join the tournament or process 2000, processor(s) 91, 100, 300 can generate, in response to each join tournament request data set received at (1), a corresponding tournament authorization token data set, each tournament authorization data set comprising data representing at least a secure tournament participation token and at least one tournament game 2000 the corresponding gamer 90 is authorized to access, and can route the tournament authorization token data set(s) to corresponding gamer communication device(s) 10, via the same or other data communication networks.

At (3) in FIG. 1, processor(s) 91, 100, 200 can receive, from a plurality of gamer communication devices 10, via the same or another network communication system, signals representing a plurality of game action command data sets, each game action command data set comprising at least data representing a secure tournament authorization token associated with an authorized gamer 90 authorized and data indicating a game action to be performed by the gaming server 100, 200, 300 on behalf of the authorized gamer.

At (4) and (5a) in FIG. 1, conditioned upon receipt of a secure authorization token and without further reference to a gamer account associated with a corresponding gamer, processor(s) 91, 100, 200 can execute the indicated game action and update a tournament status data set 92, 600, generate a game action result data set comprising at least the same or another tournament authorization token data set and data representing a game action result associated with the executed game action; and route generated the game action result data set to the corresponding gamer communication device 10.

In further aspects and embodiments, the invention provides sequestered unpredictable number generators 500 as described above, each of which can for example comprise one or more data processors 98; one or more secure machine-readable memories 502 accessible by the one or more data processors 98; and one or more network communication systems 99. The memory(ies) 502 can comprise data representing stored, machine-interpretable instructions configured to cause the data processor(s) 500, 98 to generate a plurality of unpredictable numbers; store the plurality of generated unpredictable numbers in the memory(ies) 502; receive from one or more gaming server 100, 200 via the at least one network communication system 99, at least one unpredictable number request data set; and, responsive to receipt of the at least unpredictable number request data set; retrieve from the at least one secure memory 502 one or more unpredictable numbers corresponding to the at least one request; and route the one or more retrieved unpredictable numbers to the at least one gaming server 100, 200.

In some embodiments, sequestered unpredictable number generators in accordance with such aspects of the invention are configured to generate and store unpredictable numbers in accordance with a plurality of generation factors; and, upon request, to return to requesting servers 100, 200 unpredictable number generated in accordance with at least a selection of the plurality of generation factors.

As described above, sequestered generators 500 of random or otherwise unpredictable numbers in accordance with such aspects and embodiments provide unique advantages for improvements in the speed and processing of processes requiring such numbers, including for example virtual slot and other gaming tournaments that require rapid parallel processing, without compromising security or other aspects of the integrity of such processing. Such advantages include advance generation and storage of numbers generated using any desired types, numbers, and combinations of operands (factors), techniques, and algorithms, for very rapid return on request.

Thus, in various embodiments, the invention further provides gaming servers 100 in accordance with the foregoing, wherein executing a game action associated with a game action command data set comprises use of an unpredictable number generated by a sequestered unpredictable number generation server 500, 501 in advance of receipt by the gaming server of the game action command data set.

Therefore, among further improvements offered by aspects of the invention pertaining to bifurcation of outcome-determining and other processes associated with individual users is the use of secure, dedicated engines to determine random results of gaming processes in accordance with pre-established rules, store the pre-determined random results, for example in the order of their generation, and route them to gaming engine(s) 200 on request, in accordance with pre-established procedures.

For example, as shown in FIG. 1 one or more “random number” generators (RNGs) 500 can be used to generate random numbers in accordance with any desired pre-defined rules, such as results of 3, 4, or 5-wheel slot machine pulls, each slot wheel comprising a defined number of possible results (sometimes called ‘stops). The RNGs can continuously generate results of such random activities, and store them in one or more data sets 502, for example in the order in which they were generated. When a gaming engine 200 requires the result of such a slot pull, the engine 200 can route to the RNG 500 a request for a pre-generated result, and can be provided with one, typically in a shorter period of time than the engine 200 could generate one itself. Thus the speed of providing results to the engine 200, device 10, and/or tournament engine 300 can be decreased significant.

As will be appreciated by those skilled in the relevant arts, the generation and release of pre-generated random results can be controlled in any desired or otherwise appropriate fashion. Simple examples include first in—first out, last in—first out processes, etc.

Thus in cases where, for example, a user wishes to rapidly execute a series of gaming commands, the speed with which the user is permitted to do so can be limited only by completion of the outcome-determinative processes and both individual and tournament processing can be expedited. For example, a user 90 can rapidly route ‘slot pull’ commands from his/her device 90 to a gaming engine 200, which gaming engine can rapidly pull corresponding slot result data sets from an RNG 500, track the results and report some or all of them to either or both of the user device 10 and a tournament engine 300, which tournament engine can collate performance of multiple tournament players and report results to either or both of user device(s) 90 and global queue 400, and global queue 400 can report tournament stage results to users of all participating devices 900.

As will be appreciated by those skilled in the relevant arts, many so-called ‘random’ processes executed by computer systems can best described as pseudo-random processes. In this disclosure the term ‘random’ is intended to apply to both random and pseudo-random processes, unless otherwise indicated.

In further aspects and embodiments, the invention provides both volatile and persistent machine-interpretable media comprising data representing instructions for causing processor(s) 900 and other components of controller(s) 10, 111 to implement any and all of the described processes.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

What is claimed is:

1. A network communication device configured to operate a gaming application for participation by a gamer in a tournament game process, the device comprising:
at least one data processor;
at least one input device and at least one output device;
at least one machine-readable memory accessible by the at least one data processor; and
at least one network communication system;
the at least one memory comprising data representing stored, machine-interpretable instructions configured to cause the at least one data processor to:
in accordance with signals received from the at least one input device, access data in the at least one memory representing a tournament gaming application, and initiate the application;
using the at least one network communication system, route signals representing a join tournament request data set to a gaming server;
using the same or another network communication system, receive from the same or another gaming server signals representing a tournament authorization token data set, the tournament authorization data set comprising data representing a secure authorization token for participation by a gamer in a tournament game process;
in accordance with signals received from the same or another input device, generate a first game action command data set, the first game action command data set comprising at least data representing the same or another tournament authorization token and data indicating a game action to be performed by the same or another gaming server on behalf of the gamer;
route the first game action data set to the same or another gaming server;
display on the at least one output device at least one placeholder image; and
conditioned upon receipt by the at least one processor, from the same or another gaming server, of a first game action result data set, comprising at least the same or another tournament authorization token data set and data representing a first game action result, prior to receipt by the at least one processor, from the same or another input device, of signals representing at least one subsequent game action command data set, each subsequent game action command data set comprising at least data representing the same or another tournament authorization token and data indicating a subsequent game action to be performed by the same or another gaming server on behalf of the gamer; display on the at least one output device a user interface communicating a current game status associated with first game action result.

2. A network communication device configured to operate a gaming application for participation by a gamer in a tournament game process, the device comprising:
at least one data processor;
at least one input device and at least one output device;
at least one machine-readable memory accessible by the at least one data processor; and
at least one network communication system;
the at least one memory comprising data representing stored, machine-interpretable instructions configured to cause the at least one data processor to:
in accordance with signals received from the at least one input device, access data in the at least one memory representing a tournament gaming application, and initiate the application;
using the at least one network communication system, route signals representing a join tournament request data set to a gaming server;
using the same or another network communication system, receive from the same or another gaming server signals representing a tournament authorization token data set, the tournament authorization data set comprising data representing a secure authorization token for participation by a gamer in a tournament game process;
in accordance with signals received from the same or another input device, generate a first game action command data set, the first game action command data set comprising at least data representing the same or another tournament authorization token and data indicating a game action to be performed by the same or another gaming server on behalf of the gamer;
route the first game action data set to the same or another gaming server;
conditioned upon receipt by the at least one processor, via the same or another network communication system and from the same or another gaming server, of a tournament result data set comprising data representing at least one tournament result, display on the at least one output device a user interface associated with the at least one tournament result;
else, further conditioned upon receipt by the at least one processor from the same or another input device of signals representing at least one subsequent game action command,
generate a subsequent game action command data set corresponding to each such subsequent game action command, each subsequent game action command data set comprising at least data representing the same or another tournament authorization token and data indicating a subsequent game action to be performed by the same or another gaming server on behalf of the gamer; and
route to the same or another gaming server a subsequent game execution data set corresponding to each subsequent game action command data set received by the at least one processor;
else, further conditioned upon receipt, via the same or another network communication system and from the same or another gaming server, of a game action result data set, comprising at least a tournament authorization token data set and data representing a game action result, display on the at least one output device a user interface associated with the game action result data set;
else, display on the at least one output device at least one placeholder image.

3. A tournament gaming server, comprising:
at least one data processor;
at least one machine-readable memory accessible by the at least one data processor; and
at least one network communication system;
the at least one memory comprising data representing stored, machine-interpretable instructions configured to cause the at least one data processor to:
receive, from a plurality of gamer communication devices, via the at least one network communication system, signals representing a plurality of join tournament request data sets, each join tournament request data set comprising at least data associated with an identity of a gamer associated with a gaming account administered by the gaming server and a request to join a tournament game;
with respect to each received join tournament request data set, access in the at least one machine-readable memory data associated with the gaming account associated with the corresponding gamer and determine whether the corresponding gamer is authorized to join a tournament associated with the corresponding request;
conditioned upon determination that the corresponding gamer is authorized to join the tournament, generate, in response to each received join tournament request data set, a corresponding tournament authorization token data set, each tournament authorization data set comprising data representing at least a secure tournament participation token and at least one tournament game the corresponding gamer is authorized to access;
route, via the same or another network communication system, each generated tournament authorization token data set to a corresponding gamer communication device;
receive, from a plurality of gamer communication devices, via the same or another network communication system, signals representing a plurality of game action command data sets, each game action command data set comprising at least data representing a secure tournament authorization token associated with an authorized gamer authorized and data indicating a game action to be performed by the gaming server on behalf of the authorized gamer;
conditioned upon receipt of a secure authorization token and without further reference to a gamer account associated with a corresponding gamer, execute the indicated game action and update a tournament status data set, generate a game action result data set comprising at least the same or another tournament authorization token data set and data representing a game action result associated with the executed game action; and route generated the game action result data set to the corresponding gamer communication device.

4. The tournament gaming server of claim 3, wherein executing a game action associated with a game action command data set comprises use of an unpredictable number generated by a sequestered unpredictable number generation server in advance of receipt by the gaming server of the game action command data set.

5. A sequestered unpredictable number generator comprising:
at least one data processor;
at least one secure machine-readable memory accessible by the at least one data processor; and
at least one network communication system;
the at least one memory comprising data representing stored, machine-interpretable instructions configured to cause the at least one data processor to:
generate a plurality of unpredictable numbers;
store the plurality of generated unpredictable numbers in the at least one secure memory;
receive from at least one gaming server, via the at least one network communication system, at least one unpredictable number request data set;
responsive to receipt of the at least unpredictable number request data set;
retrieve from the at least one secure memory one or more unpredictable numbers corresponding to the at least one request; and
route the one or more retrieved unpredictable numbers to the at least one gaming server.

6. The sequestered unpredictable number generator of claim 5, wherein:
the unpredictable numbers stored in the at least one secure memory comprise unpredictable numbers generated in accordance with a plurality of generation factors; and
the at least one unpredictable number request data set comprises data representing at least one request for an unpredictable number generated in accordance with at least a selection of the plurality of generation factors.
